(19) United States
(12) Patent Application Publication
(10) Pub. No.: US 2007/0252407 A1
(43) Pub. Date: Nov. 1, 2007

(54) Latch arrangement

(76) Inventors: Denis Cavallucci, Otterswiller (FR); Gurbinder Singh Kalsi, West Midlands (GB); Chris Rhodes, Orleans (FR); Nigel Victor Spurr, Solihull (GB); Sylvain Rehi Chonavel, Sully Sur Loire (FR); David Peatey, Solihull (GB); Paul Moore, Kings Norton (GB); Robert Frank Tolley, Staffordshire (GB); Jean-Vincent Olivier, Colmar (FR); Robert James Clawley, Staffordshire (GB)

Correspondence Address: CARLSON, GASKEY & OLDS, P.C., 400 WEST MAPLE ROAD, SUITE 350, BIRMINGHAM, MI, 48009, US

(21) Appl. No.: 11/591,291

(22) Filed: Nov. 1, 2006

(30) Foreign Application Priority Data
Nov. 7, 2005 (GB) 0522668.3

(51) Int. Cl. B60J 5/00

(52) U.S. Cl. 296/146.4

(57) ABSTRACT

A latch arrangement includes a power control system which can be energized to prevent opening of a door latch by controlling the movement of a release mechanism within a latch. A sensor monitors an operative state of the release mechanism. In the event the sensor detects an unauthorized attempt to open a door, the power control system is energized, thereby preventing unauthorized opening of the latch. The sensor can monitor the direct movement of a door handle. Additionally, or alternatively, the sensor can monitor an internal component within the release mechanism to monitor movements indicative of movement of the door handle.

### REFERENCE TO RELATED APPLICATION

This application claims priority to United Kingdom Patent Application GB 0522668.3 filed on Nov. 7, 2005.

### BACKGROUND OF THE INVENTION

The present invention relates generally to a latch arrangement, more particularly, but not exclusively, to a latch arrangement for use within a door of an automotive vehicle.

Known car doors include latches for releasably retaining the door in a closed position. The latches can be locked when the car is left unattended, or even when a vehicle is occupied, to prevent access to the vehicle by unauthorized persons.

The latches can be moved between a locked condition and an unlocked condition either manually by operating an inside sill button or an exterior key barrel, or by powered actuation by a power actuator which can be controlled remotely by, for example, infrared devices.

A problem with such power locking/unlocking is that in the event that power is lost, e.g., during a road traffic accident or as a result of a dead battery, it may not be possible to change the state of the lock. Thus, if a vehicle is being driven with its door locked and the vehicle is involved in a serious collision, the occupant of the vehicle may be locked in the vehicle, which has safety implications.

A known form of door latch which addresses this problem is described in EP 1217153, where an electromagnet is utilized to prevent manual opening of the door when the vehicle is in use. More particularly, when energized, the electromagnet attracts a ferromagnetic end of a control lever, thereby preventing the control lever from moving to an unlocking position. In the event of a collision, the loss of power to the electromagnet enables the control lever to move to the unlocking position so that the door can be manually opened. However, a disadvantage is the constant power consumption of the electromagnet to provide this locking feature.

It is an object of the invention to provide an improved form of a latch arrangement.

### SUMMARY OF THE INVENTION

The present invention provides a latch arrangement including a latch, a manually actuable element, a release mechanism and a power control system. The latch is operable to releasably retain a striker in use, and the release mechanism is capable of being moved by the manually actuable element from a latched position to an unlatched position wherein the release mechanism unlatches the latch. The power control system has an active condition for preventing the release mechanism from unlatching the latch and a passive condition for permitting the release mechanism to unlatch the latch. The power control system is configured to switch from the passive condition to the active condition in response to a movement of the manually actuable element to protect against unauthorized opening of the latch.

### BRIEF DESCRIPTION OF THE DRAWINGS

Other aspects and features of the invention will be readily apparent from the dependent claims and the following description, which is made, by way of example only, with reference to the accompanying drawings, in which:

FIG. 1 is a view of a latch arrangement according to the present invention;

FIG. 1A is an enlarged view of part of the latch arrangement of FIG. 1;

FIG. 1B is a view similar to FIG. 1A showing a magnetic pawl in a different position;

FIG. 2 shows the latch arrangement of FIG. 1 partially through an opening operation in an unlocked, but latched condition;

FIG. 3 shows the latch arrangement of FIG. 1 at an end of the opening operation in an unlatched condition; and

FIG. 4 shows the latch arrangement of FIG. 1 wherein an attempt has been made to open the latch while in a locked condition.

### DETAILED DESCRIPTION OF THE PREFERRED EMBODIMENT

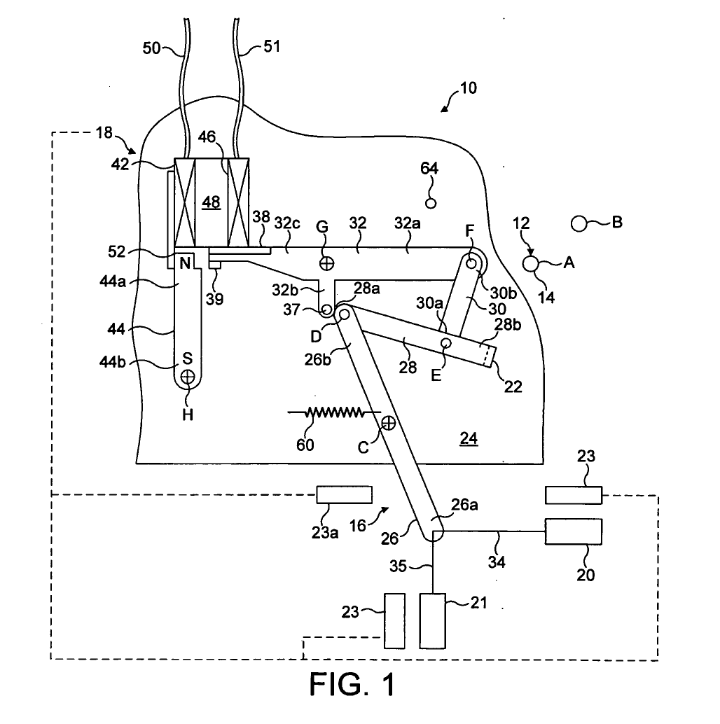

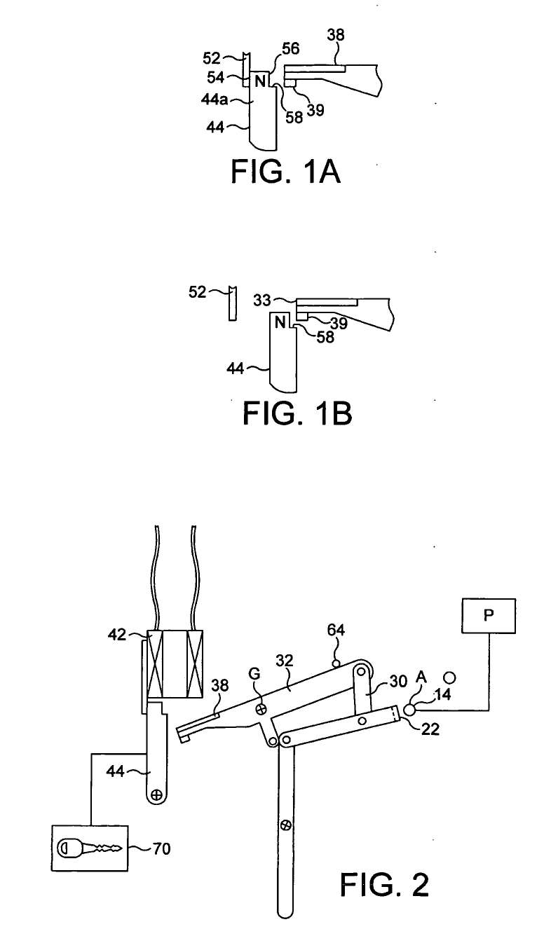

With reference to the FIGS. 1 to 4, a latch arrangement 10 includes a latch 12 (only part of which is shown in the Figures), a release mechanism 16, a powered control system 18 and manually actuable elements in the form of an inside door handle 20 and an outside door handle 21.

Although not illustrated, the latch 12 is mounted on a car door and is operable to releasably retain a striker (not shown) mounted on a fixed structure of the car, such as a B post (not shown) or a C post (not shown). Further, the latch 12 includes a latch bolt in the form of a rotating claw (not shown) for engaging the striker to hold the door in a closed position. A pawl arrangement (not shown) biases the rotating claw into engagement with the striker, thereby retaining the rotating claw in a closed position. The pawl arrangement includes a latch release element, which in one example is a pawl pin 14.

The pawl pin 14 is movable between a position A and a position B shown in FIG. 1. With the pawl pin 14 in the position A, closing of the door will cause the rotating claw to rotate and engage the striker. The pawl arrangement will then retain the striker in the closed position. Subsequent movement of the pawl pin 14 to the position B releases the pawl arrangement from engagement with the rotating claw, thus allowing the rotating claw to be released from the striker and allowing the door to open. Thus, with the pawl pin 14 in the position A, the latch 12 can be “latched” to the striker, and with the pawl pin 14 in the position B, the latch 12 can be “unlatched” from the striker. The release mechanism 16 includes a release lever 26, a release link 28, a connector link 30 and a lock/unlock lever 32.

The release lever 26 is pivotally mounted about a pivot C on a chassis 24 of the latch arrangement 10. One end 26A of the release lever 26 is connected via a linkage 34 (shown schematically) to a first manually actuable element in the form of the inside door handle 20. The end 26A is also connected by a further linkage 35 (shown schematically) to a second manually actuable element in the form of the outside door handle 21. Operation of either the inside door handle 20 or the outside door handle 21 causes the release lever 26 to rotate clockwise about the pivot C.

In this embodiment, a sensor 23 is provided in operative communication between the outside door handle 21 and the powered control system 18. The sensor 23 is configured for detecting movement of the outside door handle 21 and generating a signal indicative of movement for processing by the powered control system 18, as will be described in more detail below.

In certain embodiments, the outside door handle 21 includes a lever (not shown), and the sensor 23 includes a switch or motion sensor which is operable to detect an initial displacement of the lever from a normal rest position (for example, a movement of 2 mm) and to generate an output indicative of the movement. A similar sensor may also be provided in operative communication between the inside door handle 20 and the powered control system 18.

An opposite end 26B of the release lever 26 is connected via a pivot D to an end 28A of the release link 28. An opposite end 28B of the release link 28 includes an abutment 22 for engagement with the pawl pin 14, as will be further described below.

The release link 28 is connected to an end 30A of the connector link 30 by a pivot E positioned between the two ends 28A and 28B of the release link 28. An end 30B of the connector link 30 is connected to an end of a first arm 32A of the lock/unlock lever 32 by a pivot F.

The lock/unlock lever 32 further includes a second arm 32B having a pin 37 and a third arm 32C having an abutment 38 on an upperside and an abutment 39 on an underside. The lock/unlock lever 32 is pivotally mounted about a pivot G onto the chassis 24 of the latch arrangement 10. The abutment 38 is made from a ferromagnetic material.

The powered control system 18 includes an electromagnet 42 and a magnetic pawl 44. The electromagnet 42 is mounted on the chassis 24 and includes windings 46, a core 48 and electric leads 50 and 51. A pawl stop 52 is provided on one side of the electromagnet 42. The magnetic pawl 44 includes a permanent magnet and is pivotally mounted about a pivot H onto the chassis 24. An end 44A of the magnetic pawl 44 includes abutments 54, 56 and 58, which will be further described below.

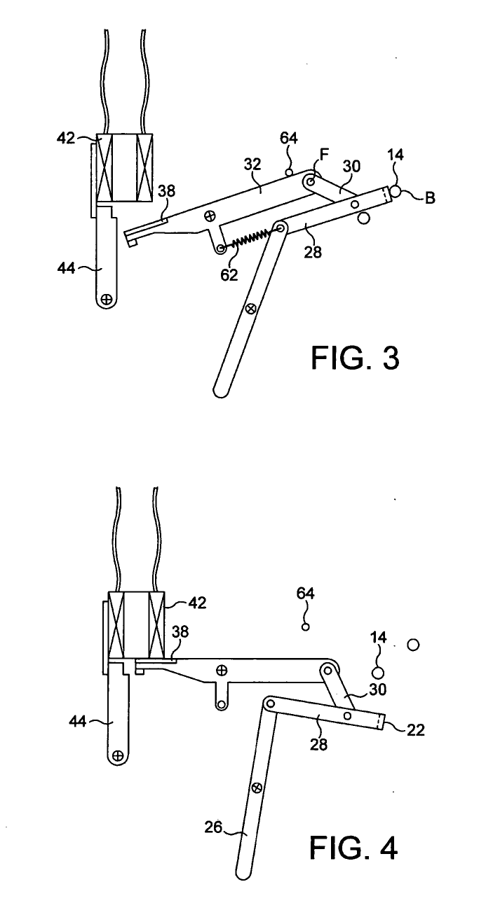

A tension spring 60 is connected between the chassis 24 and the release lever 26 and acts to bias the release lever 26 in a counter-clockwise direction, as viewed in FIG. 1. A further tension spring 62 (only shown in FIG. 3 for clarity) biases the pin 37 and the pivot D together. In further embodiments, different forms of springs can be used, in particular springs acting in torsion (clock springs) can be used in place of the tension springs 60 and 62 to perform the same biasing action.

A lock/unlock lever stop 64 is mounted on the chassis 24. As a result of the tension spring 62, the end 28A of the release link 28 is biased into engagement with the pin 37. In further embodiments, the end of the release lever 26 could engage the pin 37, as could a part of the pivot D.

The magnetic pawl 44 has a south pole at an end 44B and a north pole at the end 44A. If a DC current is applied to the windings 46 via electric leads 50 and 51 in a first direction, a magnetic field is created around the electromagnet 42 which will bias the end 44A of the magnetic pawl 44 to the left as viewed in FIG. 1, i.e., counter-clockwise about the pivot H until the abutment 54 engages the pawl stop 52.

Applying a DC current in a second direction causes a different magnetic field to form around the electromagnet 42 such that the end 44A of the magnetic pawl 44 is biased to the right as viewed in FIG. 1, i.e., clockwise around the pivot H until the abutment 56 engages an end 33 of the third arm 32C of the lock/unlock lever 32 (see FIG. 1B). Under these conditions, the abutment 58 is opposite the abutment 39 and will prevent rotation of the lock/unlock lever 32 counter-clockwise about the pivot G (see below).

To move the magnetic pawl 44 between the positions shown in FIGS. 1A and 1B, it is only necessary to apply a short pulse (e.g., 50 ms) of current to the windings 46 in the appropriate direction because under normal circumstances, once the magnetic pawl 44 has achieved one of the positions shown in FIGS. 1A or 1B, there are no forces which tend to move the magnetic pawl 44 out of the position.

In a preferred embodiment, a center of gravity of the magnetic pawl 44 is substantially at the pivot H because such an arrangement will not tend to rotate the magnetic pawl 44 as a result of acceleration or deceleration forces that occur during the accident in the event of a road traffic accident (i.e., to prevent undesired movement of the magnetic pawl 44 to the blocking position shown in FIG. 1B).

In a further preferred embodiment, a relatively light detent is provided to maintain the magnetic pawl 44 in either of the positions shown in FIGS. 1A and 1B, which can be overcome by manual operation of the magnetic pawl 44 via an external key (for example) or by pulsing the electromagnet 42.

It is also possible to prevent rotation of the lock/unlock lever 32 counter-clockwise about the pivot G by applying and maintaining DC current to the windings 46 in the first direction because the abutment 38 made from a ferromagnetic material will be magnetically attracted to the electromagnet 42.

The powered control system 18 has three conditions, as follows: 1) a first condition in which no power is supplied to the windings 46 and the magnetic pawl 44 is in the position shown in FIG. 1B, 2) a second condition in which power is supplied and maintained in the first direction to windings 46, thus attracting the abutment 38 and ensuring that the magnetic pawl 44 is positioned as shown in FIGS. 1 and 1A, and 3) a third condition in which no power is supplied to the windings 46 and the magnetic pawl 44 is in position as shown in FIGS. 1 and 1A.

In this case, the physical position of various components when in the second condition and the third condition is the same. Thus, the second condition and the third condition differ only in that power is supplied to windings 46 in the second condition, whereas no power is supplied in the third condition.

Operation of the latch arrangement 10 is as follows. With the powered control system 18 in the third condition, the door can be manually opened as follows. With the powered control means 18 in the third condition, the magnetic pawl 44 is arranged in the position shown in FIG. 1 and thus does not restrict rotation of the lock/unlock lever 32 in a counter-clockwise direction. Furthermore, no power is supplied to the windings 46, and thus the electromagnet 42 also does not restrict movement of the lock/unlock lever 32 in a counter-clockwise direction.

Initial movement of either the inside door handle 20 or the outside door handle 21 moves the release lever 26 in a clockwise direction about the pivot C to the position shown in FIG. 2. In FIG. 2, the lock/unlock lever 32 has rotated counter-clockwise about the pivot G to a position where the first arm 32A has come into abutment with the lock/unlock lever stop 64. The abutment 38 has become disengaged from the electromagnet 42.

FIG. 2 shows that the end 28A of the release link 28 has remained in contact with the pin 37. Thus, the connector link 30 and the release link 28 have also substantially rotated about the pivot G. Furthermore, the abutment 22 has become aligned with the pawl pin 14. This can be contrasted with the position of the abutment 22 shown in FIG. 1, where the abutment 22 is not aligned with the pawl pin 14.

Further movement of the inside door handle 20 or the outside door handle 21 moves the release lever 26 from the position shown in FIG. 2 to the position shown in FIG. 3.

In view of the fact that the first arm 32A of the lock/unlock lever 32 is in abutting engagement with the lock/unlock lever stop 64, the lock/unlock lever 32 cannot rotate further in a counter-clockwise direction. Thus, the connector link 30 is caused to rotate counter-clockwise about the pivot F relative to the lock/unlock lever 32. This results in the abutment 22 of the release link 28 moving into engagement with the pawl pin 14 and moving it from the position A shown in FIG. 2 to the position B shown in FIG. 3.

As previously mentioned, movement of the pawl pin 14 from the position A to the position B causes the latch 12 to become “unlatched.”

When the inside door handle 20 and the outside door handle 21 are released, the tension spring 60 and the further tension spring 62 return the release mechanism 16 and the pawl pin 14 to the position shown in FIG. 1.

While the movement of the inside door handle 20 or the outside door handle 21, and hence the movement of the release lever 26, has been described in two stages, the two stage movement is not discernible by a person operating the inside door handle 20 and the outside door handle 21. Furthermore, the mechanism is designed to move seamlessly from the position shown in FIG. 3 to the position shown in FIG. 1.

With the powered control system 18 in the second condition, hereinafter referred to the active condition, i.e., in which a DC current is supplied to the windings 46 in the first direction and the magnetic pawl 44 is in a position as shown in FIG. 1, the lock/unlock lever 32 is maintained in the position shown in FIG. 1 by magnetic attraction.

Thus, operation of the inside door handle 20 or the outside door handle 21 will cause the release lever 26 to rotate in a clockwise direction as viewed in FIG. 1, which will result in the end 28A of the release link 28 immediately disengaging the pin 37 such that the release lever 26, the release link 28 and the connector link 30 move to the position shown in FIG. 4.

While the abutment 22 is caused to move in view of the fact that it was initially misaligned with the pawl pin 14, such movement results in the abutment 22 bypassing the pawl pin 14 and not imparting any movement to the pawl pin 14. Thus, while the inside door handle 20 or the outside door handle 21 has been moved, the door has not become unlatched. In further embodiments, it is possible to arrange an abutment (such as the abutment 22) to be permanently aligned with a latch release element (such as the pawl pin 14), but remote therefrom, such that with the latch arrangement 10 in a locked condition, the abutment 22 approaches the pawl pin 14 but does not move the pawl pin 14. With the latch arrangement 10 in an unlocked condition, the abutment 22 approaches, engages and then moves the pawl pin 14.

With the powered control system 18 in the active condition, the latch 12 remains in a locked condition. In accordance with the preferred embodiment of the invention, the powered control system 18 is configured to switch to the active condition, i.e., wherein power is supplied to the electromagnet 42, to protect against unauthorized opening of the latch 12.

More particularly, if the vehicle is in use (i.e., with the ignition switched on, either when stationary or when moving), the powered control system 18 is arranged to communicate with the sensor 23 associated with the respective door handles 20 and 21 for determining whether an attempt has been made to open the door using the door handles 20 and 21.

If a person attempts to open the door using one of the inside door handle 20 and the outside door handle 21, the associated sensor 23 detects the initial movement of the outside door handle 21, and the powered control system 18 instantaneously initiates power to the windings 46. Hence, during the initial movement of the outside door handle 21, the powered control system 18 operates to switch from an inactive condition to an active condition to prevent unauthorized access to the vehicle. In particular, the powered control system 18 is configured to move the lock/unlock lever 32 into magnetic abutment with the electromagnet 42 before the release lever 26 has been able to position the abutment 22 of the release link 28 in alignment with the pawl pin 14 in the position A.

An override facility may be provided to selectively prevent the powered control system 18 from its operative cooperation with the sensor 23 in the manner described above when the vehicle is in use.

With the powered control system 18 in the first condition, i.e., where there is no power to the windings 46 but the magnetic pawl 44 is in the position shown in FIG. 1B, counter-clockwise rotation of the lock/unlock lever 32 is again prevented, though this time by cooperation of the abutments 39 and 58. Thus, actuation of the inside door handle 20 or the outside door handle 21 will again cause the release lever 26, the release link 28 and the connector link 30 to move to the position shown in FIG. 4.

FIG. 2 shows schematically a power actuator P which is independently operable to release the latch 12. Further shown schematically is a coded security device 70 in the form of an externally mounted key barrel into which a key can be inserted. Actuation of the key barrel via the key is capable of moving the magnetic pawl 44 between the positions shown in FIGS. 1A and 1B

The powered control system 18 is configured to be in active communication with the sensor(s) 23 when the associated vehicle is in use to be operable to switch to the active condition upon undesired or unauthorized movement of a respective door handle 20 or 21.

With the vehicle in use and the powered control system 18 in an active condition, the lock/unlock lever 32 is maintained in the position shown in FIG. 1 by power fed to the electromagnet 42. The powered control system 18 remains in the active condition until it detects, via the sensor 23, that the respective door handle 20 or 21 has returned to the normal rest position.

In the event of a power failure, such as might occur following a road traffic accident, the powered control system 18 will by definition change to the third condition and hence the doors will become unlocked, and occupants of the vehicle will be able to escape from the vehicle.

When the vehicle is parked and left unattended, the powered control system 18 can be set to the first condition to lock the latch 12. Alternatively, the powered control system 18 can be set to the third condition when the vehicle is parked and is required to be in an unlocked condition. Note that in the first condition and the third condition, there is no drain on the battery. The powered control system 18 can be changed between the first condition and the third condition by applying a pulse of electrical power to the windings 46 in an appropriate direction.

With the vehicle parked and with the powered control system 18 in the first condition, i.e., with the vehicle locked, pulsing of the electromagnet 42 to move the powered control system 18 from the first condition and the third condition to unlock the vehicle will not be possible if the vehicle battery is dead, perhaps as a result of an interior light being left on. However, it is nevertheless possible to manually unlock the vehicle by use of the coded security device 70. The coded security device 70 can also be used to lock the vehicle if necessary.

The invention is particularly advantageous in providing an efficient way of preventing unauthorized access to the vehicle when in use, as well as providing an efficient child safety lock for preventing undesired or accidental opening of the door from the inside when the vehicle is in use. Only a relatively small movement of the inside door handle 20 or the outside door handle 21 is required to induce the electromagnet 42 and prevent unlatching of the door.

Only when the vehicle is in use and the powered control system 18 is in its active condition, i.e., when the sensor 23 detects that a door handle 20 or 21 has been moved from the rest position to a door opening position, is power continually fed to windings 46, thereby minimizing power consumption during driving of the vehicle.

The electromagnet 42 needs to be strong enough to retain the lock/unlock lever 32 in the position shown in FIG. 1 when the electromagnet 42 is in the active condition, i.e., when power is being supplied to the electromagnet 42. Thus, the electromagnet 42 has to be strong enough to overcome the forces in the tension spring 60 during initial movement of inside door handle 20 or the outside door handle 21, and it has to overcome the forces in the tension spring 60 and the further tension spring 62 during a subsequent movement of the inside door handle 20 or the outside door handle 21. Furthermore, the electromagnet 42 needs to be strong enough to move the lock/unlock lever 32 from the position shown in FIG. 2 to a position such that the abutment 38 engages with the electromagnet 42.

The invention has an application in any form of vehicle door latch wherein unlatching of the door is prevented if an unauthorized or undesired movement of an internal or external door handle is detected, and the invention is therefore not limited to the illustrated embodiment.

In alternative embodiments, the sensor 23 described above may be arranged in direct communication with a portion of the latch 12 rather than in direct communication with a respective inside door handle 20 or outside door handle 21. For example, a switch or motion sensor may be arranged to detect movement of a linkage or lever within the latch 12, provided that the linkage or lever would normally be caused to move in response to a typical opening operation of the inside door handle 20 or the outside door handle 21. In the embodiment of FIG. 1, the sensor 23 may be arranged to detect motion of the release lever 26 or the release link 28 because these latch components are only caused to be moved in an opening direction if one or both of the inside door handle 20 or the outside door handle 21 is moved significantly from the normal rest position, for example after the take up of any slack between the release lever 26 and the door handles 20 or 21.

In such embodiments, the sensor 23 is therefore arranged in indirect communication with the inside door handle 20 and the outside door handle 21 for detecting movement within the latch 12 which is indicative of a determined opening movement of the inside door handle 20 and the outside door handle 21. Hence, only if one of the inside door handle 20 and the outside door handle 21 is moved in a manner which would indicate an intention to open the door using the door handle 20 or 21 will the linkage within the latch 12 be caused to move to trigger a signal in the associated sensor and thereby cause the powered control system 18 to switch to the active condition. However, such an arrangement prevents the powered control system 18 from switching to the active condition in the event of minor movements or vibrations of the release levers, such as may be experienced if the vehicle is travelling over rough terrain.

In a preferred embodiment, the latch 12 includes a first sensor in direct communication with the inside door handle 20, a second sensor in direct communication with the outside door handle 21, and a third sensor arranged in direct communication with the release lever 26 (see the release lever sensor 23A in FIG. 1, which is also arranged in communication with the powered control system 18 in the same manner as the sensors 23 associated with the inside door handle 20 and the outside door handle 21).

In this embodiment, the release lever 26 is caused to begin to move in an opening direction, i.e., to rotate about the pivot point C in a clockwise direction as viewed in FIG. 1, only in response to a significant movement of one or more of the door handles 20 and 21 from their normal rest position. The opening movement of the release lever 26 occurs almost instantaneously during normal opening operation of the inside door handle 20 and the outside door handle 21.

In this embodiment, the powered control system 18 is configured to switch to the active condition only if it receives a signal from the release lever sensor 23A and one or more of the sensors 23, i.e., only if the powered control system 18 determines that the release lever 26 and one or more of the inside door handle 20 and the outside door handle 21 has been moved in a manner indicative of an attempt being made to open the door using one of the door handles 20 or 21. If a signal is received from one of handle sensors 23 and from the release lever sensor 23A, then the powered control system 18 will energize the electromagnet 42 to prevent the lock/unlock lever 32 from rotating to a release position.

The use of at least two sensors arranged in communication between the powered control system 18 and one or more of the inside door handle 20 and the outside door handle 21, as in the manner described above, can be advantageous in preventing unnecessary switching of the powered control system 18 to the active condition, thereby reducing overall power consumption by the latch 12. In effect, the release lever sensor 23A serves as a safety sensor remote from the inside door handle 20 and the outside door handle 21. More than one such safety sensor may be positioned within the latch 12 for detecting movement indicative of movement of one of the door handles 20 and 21 where the powered control system 18 can be configured to switch to the active condition only if it detects a signal from each safety sensor.

The electromagnet 42 may be replaced with a positive blocking element for anti-rotational engagement with the lock/unlock lever 32. For example, a piezoelectric beam or bimetallic strip of the type referred to in the Applicant's co-pending British patent application GB0522666.7 or the corresponding U.S. patent application claiming priority therefrom (incorporated herein by reference) can be incorporated into the latch 12 instead of the electromagnet 42. In such embodiments, the blocking element adopts a non-blocking position in the absence of power thereto, whereby the lock/unlock lever 32 is free to rotate in order for the latch 12 to be openable. However, if power is supplied to the blocking element, e.g., in the event that one or more of the sensors detects a movement of the inside door handle 20 and the outside door handle 21, it adopts a blocking position in engagement with the abutment 39 to prevent rotation of the lock/unlock lever 32 and thereby prevent opening of the latch 12.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

1. A latch arrangement comprising:
a latch operable to releasably retain a striker in use;
a manually actuable element;
a release mechanism, capable of being moved by the manually actuable element from a latch position to an unlatched position wherein the release mechanism unlatches the latch; and
a power control system having an active condition for preventing the release mechanism from unlatching the latch and a passive condition for permitting the release mechanism to unlatch the latch, wherein the power control system is configured to switch from the passive condition to the active condition in response to a movement of the manually actuable element to protect against unauthorized opening of the latch.

2. The latch arrangement according to claim 1, including a sensor in communication with the power control system for detecting movement of the manually actuable element, wherein the sensor is arranged to generate a signal if movement of the manually actuable element is detected; for switching the power control system to the active condition.

3. The latch arrangement according to claim 2, wherein the manually actuable element includes a lever having a normal rest position, and the sensor includes a switch which is operable to detect an initial displacement of the lever from the normal rest position.

4. The latch arrangement according to claim 3, wherein the sensor is configured to generate a control signal if the lever is displaced by at least 2 mm from the normal rest position.

5. The latch arrangement according to claim 3, wherein the sensor is connected to the lever.

6. The latch arrangement according to claim 5, wherein the sensor is configured to generate a control signal if the lever is displaced by at least 2 mm from the normal rest position.

7. The latch arrangement according to claim 1, including a sensor in communication with the power control system for detecting movement within the release mechanism that is indicative of movement of the manually actuable element.

8. The latch arrangement according to claim 1, including a first sensor in association with the manually actuable element for detecting movement thereof and a second sensor in association with a portion of the release mechanism for detecting movement thereof, wherein the power control system is configured to switch to the active condition only in response to a signal from both the first sensor and the second sensor.

9. The latch arrangement according to claim 1, wherein the power control system includes an electromagnet, and the release mechanism includes a ferromagnetic portion arranged for attraction by the power control system to prevent unlatching of the latch when the power control system is in the active condition.

10. The latch arrangement according to claim 1, wherein the release mechanism includes a lever movable to an opening position, and the power control system includes a blocking device adapted to move to a blocking position for preventing movement of the lever when the power control system is in the active condition.

11. The latch arrangement according to claim 1, wherein the manually actuable element forms part of a vehicle door handle for movement in opening a door.
